(19) United States
(12) Patent Application Publication
(10) Pub. No.: US 2026/0065757 A1
(43) Pub. Date: Mar. 5, 2026

(54) MEDIA MANAGEMENT OPTIMIZATION FOR TRANSACTION TERMINALS

(71) Applicant: NCR Voyix Corporation, Atlanta, GA (US)

(72) Inventors: Itamar David Laserson, Givat Shmuel (IL); Shay Marom, Kiryat Tiv'on (IL)

(21) Appl. No.: 18/821,330

(22) Filed: Aug. 30, 2024

(51) Int. Cl. G07G 1/00

(52) U.S. Cl. CPC G07G 1/0009

(57) ABSTRACT

Optimized cash management in retail environments is provided using machine learning techniques and predictive analytics. Long-term cash management schedules are generated for multiple self-checkout terminals, based on factors such as historical transaction data, cash usage patterns, and labor costs. The schedules are dynamically updated to adapt to unexpected events and minimize cash activities through consolidated replenishments, optimized timing, cross-terminal balancing, and adaptive media baseline thresholds. Lane-specific optimization is provided while considering overall store cash positions. This comprehensive approach aims to improve operational efficiency, reduce labor costs, enhance security, and increase customer satisfaction by minimizing disruptions and maintaining optimal cash levels across terminals.

### BACKGROUND

A major challenge for retail store managers is to effectively manage cash levels at self-checkout (SCO) lanes. Current mechanisms for triggering warnings of low or excess cash are suboptimal, leading to inefficient cash management practices such as replenishing or removing cash during peak store hours, degrading lanes to card-only mode, or shutting down lanes entirely. While cash service activities are needed to, for example, replenish denominations running low at a cash recycler or to remove excess denominations to prevent a SCO device's overflow bin from reaching its limit, suboptimal cash management can negatively impact operations in a multitude of ways such as by causing too many unnecessary cash service activities or not having enough service activities to support customer traffic. The consequences of inefficient cash management include wasted labor, reduced SCO availability, suboptimal cash pickup and delivery schedules, and inability to provide proper change to customers. While previous solutions have addressed real-time alerts and short-term forecasting, there remains a need for a more comprehensive, long-term approach to optimize cash management activities across multiple lanes and for extended time periods.

### BRIEF DESCRIPTION OF THE DRAWINGS

FIG. 1 is a diagram of a system for media management optimization for transaction terminals, according to an example embodiment.

FIG. 2 is a flow diagram of a method for media management optimization of a transaction terminal, according to an example embodiment.

FIG. 3 is a flow diagram of another method for media management optimization of a transaction terminal, according to an example embodiment.

### DETAILED DESCRIPTION

Retail stores face significant challenges in managing cash levels at self-checkout (SCO) lanes or terminals, which can have far-reaching consequences on operational efficiency, customer satisfaction, and overall profitability. The current mechanisms for managing cash levels are often reactive and based on static thresholds, leading to suboptimal outcomes. When cash levels reach predetermined minimum or maximum thresholds, warnings are triggered that necessitate immediate action, often at inopportune times.

These inefficient cash management practices result in several critical issues, including:
Disruption of store operations: Retailers are frequently forced to replenish or remove cash during peak store hours, leading to lane closures and reduced customer throughput. This not only inconveniences customers but also impacts the store's ability to process transactions efficiently. For stores with multiple SCO lanes/terminals, lane closures can translate to serval hours of SCO lane downtime per store per month.
Increased labor costs: The need for frequent, unscheduled cash management activities translates to significant labor costs. Store staff must be available to perform these tasks, often taking them away from other critical duties and resulting in wasted labor costs.
Security risks: Excess cash in SCO lanes presents a security concern, making the store a potential target for theft. Additionally, transporting large amounts of cash to and from the bank increases risk exposure. Transporting cash to and from the back at higher frequencies may also result in increased insurance premiums for a store. Furthermore, non-optimally scheduling cash service to remove and/or replenish cash leads to higher costs and/or shortages of cash for replenishment at the SCO lanes.
Suboptimal cash utilization: Inefficient cash management can lead to situations where some lanes have excess cash while others are running low, resulting in poor overall cash utilization across the store.
Customer dissatisfaction: When lanes are degraded to card-only mode or shut down entirely due to cash management issues, it can lead to longer wait times and frustrated customers, potentially impacting long-term customer loyalty. When an SCO terminal is unable to provide change to a customer an attendant interruption is needed or worse the customer is asked to checkout at a different SCO terminal.

To address these challenges, embodiments of the invention presented herein introduce a comprehensive and proactive approach to cash management optimization. The proposed solution leverages machine learning and advanced predictive analytics to create a holistic, long-term cash management strategy.

Various embodiments of the invention provide:
Long-term scheduling: Unlike previous solutions that focused on real-time alerts or short-term forecasting, embodiments herein provide a cash management schedule for extended periods (e.g., weekly or monthly). This allows for better planning and resource allocation.
Multi-factor optimization: A machine learning model (MLM) provided herein incorporates various parameters such as historical transaction data, cash usage patterns, labor costs, and security considerations to create a more nuanced and effective optimization strategy. The MLM utilizes advanced techniques such as deep learning and methods to process and analyze large volumes of historical transaction data, cash usage patterns, and other relevant factors. Unlike previous approaches that relied on static thresholds or simple linear forecasting, this MLM can identify complex patterns and interdependencies between various factors affecting cash flow. For example, it can recognize how different denominations of cash interact, how the status of one terminal affects others, and how external factors like time of day or seasonal trends impact cash usage. This allows for more accurate and nuanced predictions of cash needs across multiple terminals and extended time periods.
Dynamic updates: While providing a long-term schedule, the embodiments are designed to update its predictions periodically (e.g., daily) within the forecast period. This ensures that the cash management strategy remains responsive to changing conditions and unexpected events. Unexpected events or deviations from predicted cash flow patterns are handled. Real-time transaction data is continuously monitored and compared to forecasted patterns. When significant deviations are detected, triggers immediately cause updates to the cash management schedule. For instance, if an unexpected surge in cash transactions occurs, recommendations are immediately adjusted, potentially suggesting an earlier replenishment or reallocation of cash from other terminals. This adaptive approach ensures that the cash management strategy remains robust and effective even in the face of unforeseen circumstances.
Lane-specific optimization: The embodiments of the invention recognize that different SCO lanes may have varying cash flow patterns. The embodiments provide tailored recommendations for each lane, optimizing cash levels on a granular level while considering the store's overall cash position.
Minimization of cash activities: By taking a proactive and holistic approach, the embodiment of the invention aims to reduce the overall number of cash management activities. This not only saves on labor costs but also minimizes disruptions to store operations and customer service. Minimization is achieved through several innovative approaches:
   Consolidated replenishments: Instead of replenishing individual terminals multiple times throughout the day, a single, larger replenishment is scheduled that covers the needs of multiple terminals simultaneously.
   Optimized timing: By analyzing historical transaction data and predicting future cash needs replenishments are scheduled during off-peak hours, minimizing disruptions to store operations and customer service.
   Cross-terminal balancing: Recommendations for transferring excess cash from one terminal to another that's running low are provided, rather than initiating separate removal and replenishment activities.
   Adaptive thresholds: Instead of using fixed minimum/maximum cash levels, the thresholds and dynamically adjusted based on predicted transaction volumes, reducing unnecessary interventions.

With the innovative cash management optimization MLM provided herein, retailers can expect to see significant improvements in operational efficiency, reduced labor costs, enhanced security, and improved customer satisfaction. The ability to provide a forward-looking, adaptive strategy for cash management represents a substantial advancement over existing solutions, addressing the complex challenges faced by modern retail environments.

Reliance on SCO cash management activity, only when alerted, forces stores to always have an employee ready to replenish, which is not always possible. Especially for smaller stores. This optimization could become a double-edged sword. You may have reduced the number of activities to a minimum, but it is costly to have staff ready to replenish at all times. Furthermore, retailers prefer to avoid cash replenishments during store hours, and especially peak hours. The teachings herein bridge between the need to reduce and optimize cash management activity on one hand, while, on the other hand, having to structure cash management activity an make it more organized and predictable to stores.

As used herein “valuable media,” “media,” and “cash” can be used interchangeably and synonymously. This is intended to mean currency, such as any government-backed notes/bills and/or any government-backed coins. A “media type”can either be a bill or a coin. Each media type includes its own unique denominations; for example, U.S.-backed currency includes bill type denominations of $1, $5, $10, $20, $50, and $100 and include coin type denominations of 1 cent, 5 cents, 10 cents, 25 cents, 50 cents, and $1.

The phrases and terms “a media baseline prediction,” “baseline prediction,” “baseline,” and “prediction” can be used interchangeably and synonymously. Each prediction includes calculated amounts of media per media denomination needed by a terminal of a store for purposes of minimizing future media activities on the corresponding terminal while also maintaining a minimum total media volume for the store's terminals as a whole at a requested point in time. An “optimal” media baseline prediction is a prediction provided by a trained MLM, as discussed herein and below.

As discussed above, too many and/or too few cash activities can have significant impact on store operations. Consequently, a store can be unnecessarily wasting labor, reducing customer availability to terminals, increasing cash-in-transit (CIT) service provider visits and costs, increasing store interventions for terminals that are unable to provide proper change to customers, relegating a terminal's status to payment by card only transactions, and/or increasing customer dissatisfaction because of delays in performing transactions at the store.

The phrases and terms “a media baseline prediction,” “baseline prediction,” “baseline,” and “prediction” can be used interchangeably and synonymously. Each prediction includes calculated amounts of media per media denomination needed by a terminal of a store for purposes of minimizing future media activities on the corresponding terminal while also maintaining a minimum total media volume for the store's terminals as a whole at a requested point in time. An “optimal” media baseline prediction is a prediction provided by a trained MLM, as discussed herein and below.

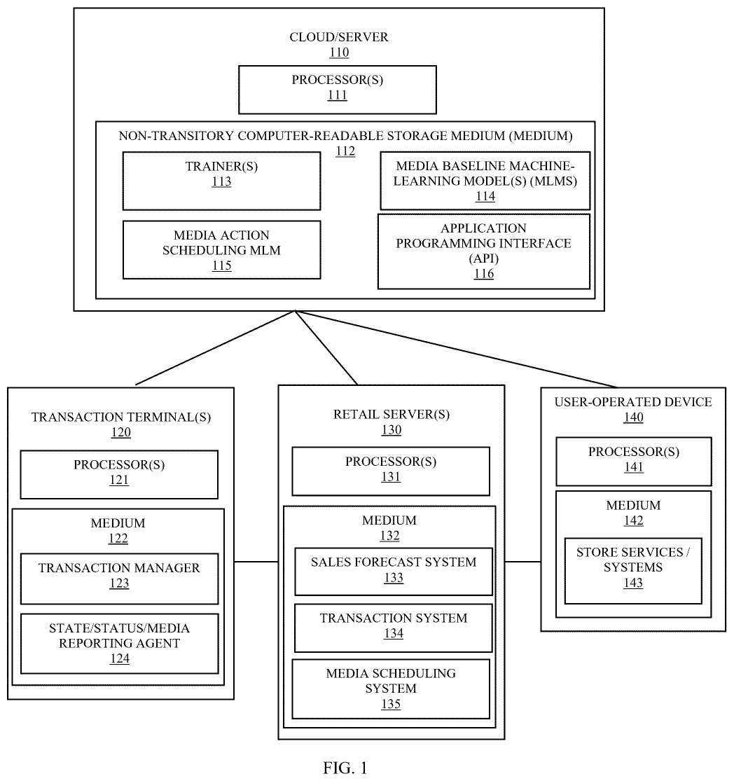

The innovative media management optimization presented herein represents a significant advancement in addressing the complex challenges faced by modern retail environments. By leveraging machine learning and advanced predictive analytics, retailers are provided with a comprehensive solution that optimizes cash management across multiple terminals and extended time periods. With its ability to adapt to changing conditions and minimize cash-related activities, the embodiments herein offer a forward-looking approach that can lead to substantial improvements in operational efficiency, cost reduction, and customer satisfaction. For added comprehension of various, FIGS. 1-3 are now discussed.

FIG. 1 is a diagram of a system 100 for providing media management optimization for transaction terminals, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of real-time and dynamic media management optimization for transaction terminals presented herein and below.

System 100 includes a cloud 110 or a server 110 (hereinafter just “cloud 110” may also be referred to herein as “cloud server 110”), transaction terminals 120, retail servers 130, and user-operated devices 140. Cloud 110 includes a processor 111 and a non-transitory computer-readable storage medium 112, which includes executable instructions for a trainers 113, a media baseline MLM 114, a media action scheduling MLM 115, and an application programming interface (API) 116. Processor 111 executes the instructions causing processor 111 to perform operations discussed herein and below with respect to 113-116.

Each transaction terminal 120 includes a processor 121 and a non-transitory computer-readable storage medium 122, which includes instructions for a transaction manager 123 and a sate/status/media reporting agent 124. Processor 121 executes the instructions causing processor 121 to perform operations discussed herein and below with respect to 123-124.

Each retailer server 130 includes a processor 131 and a non-transitory computer-readable storage medium 132, which includes executable instructions for a sales forecast system 133, a transaction system 134, and a media scheduling system 135. Processor 131 executes the instructions causing processor 131 to perform operations discussed herein and below with respect to 133-135.

Each user-operated device 140 includes a processor 141 and a non-transitory computer-readable storage medium 142, which includes instructions for one or more store services/systems 143. Processor 141 executes the instructions causing processor 141 to perform operations discussed herein and below with respect to 143.

A first trainer 113 trains media baseline 114 on input features to produce media baselines for terminal 120 using actual observed media events on terminals 120, actual observed traffic at the terminals 120, actual observed cash usage patterns at the terminals, and actual observed overall media volumes on the terminals 120 as a whole. MLM 114 is optimized to produce a media baseline for a given terminal 120 based on two target metrics 1) minimizing media activities on a given terminal 120 and minimizing total media value that is being held across all terminals 120 of a store. The media baseline provided as output from MLM 114 is a prediction for optimal media baseline on a given terminal 120 at a requested point in time. The media baseline is not a maximum and minimum value but is rather a set of optimal values representing a media total for each media denomination by media type (i.e., bill denomination and coin denomination).

Initially, first trainer 113 obtains or collects a variety of historical terminal, store, and retailer data from data sources produced by a store and/or a retailer associated with the store. The input features provided as input during training to MLM 114 are identified, derived, and/or calculated from the historical data. First trainer 113 produces the input features from the historical data as 1) historical transaction volume or rate per terminal 120 per hour, per half hour, or per quarter of an hour and historical media usage per terminal 120 per hour, per half hour, or per quarter of an hour; 2) historical real-time media usage per terminal 120 per denomination per hour, per half hour, or per quarter of an hour and historical real-time media volume levels per media denomination per terminal 120; 3) historical real-time statuses of the terminals 120 at a given store, statuses can include, closed, down, and/or degraded to no media payments can be accepted or payments only by card; 4) historical media activities, such as adding media or removing media from an overflow bin, scheduling CIT service provider visits, CIT visits; 5) historical terminal error records of the terminals 120, specifically errors that happen due to low/high media levels; and 6) historical overall media volume levels across terminals 120.

A second trainer 113 trains the media action scheduling MLM 115. The second trainer 113 collects and processes historical data to train the media action scheduling MLM 115. This data includes historical POS transaction and cash device usage per terminal 120, per hour; historical cash activities and cash readings per media denomination and per media type of each terminal 120; historical terminal statuses, including down/closed periods; sales forecasting data provided by sales forecast system 133 per specific terminal 120 for each day; and configuration data, such as a maximum cash level limit a given store is willing to accept per terminal 120.

The second trainer 113 processes this historical data to identify patterns and relationships between various factors affecting cash management needs. It segments the data into relevant time periods (e.g., daily, weekly, monthly, etc.) and associates cash management activities with the corresponding transaction and cash level data.

The media action scheduling MLM 115 is trained to produce recommendations for optimal cash management activities. The mode 115l learns to balance multiple objectives, including minimizing the total number of cash management actions/activities; maintaining media levels within acceptable ranges for each terminal 120; optimizing the timing of cash management actions/activities to minimize disruptions to store operations; and considering the overall cash position of a given store. MLM 115 is designed to generate a cash management schedule that balances the need for efficient cash management with the store's operational requirements.

The media action scheduling MLM outputs recommendations, which include replenishment dates for each terminal 120, tailored to the terminal's specific usage patterns and needs; base level denomination for each replenishment day in each terminal as provided as output from MLM 114; and a summarized schedule of cash management activities/actions, structured on a daily, weekly, and/or monthly basis, including the number of replenishment/media removal activates and expected cash levels at the end of each day. For example, the MLM 115 might recommend that terminal 1 should be replenished every day, while terminal 2 should be replenished only on Tuesday, Friday, and Saturday, based on their respective forecasted traffic and cash usage patterns.

MLM 115 also provides a summary of cash management activities/actions. As an example, this summary may appear as follows:
Monday 1/1—4 cash management replenishments/clearance activities. Total expected cash level at end-of-day (EOD)—$5432.
Tuesday 1/2- 0 cash management replenishments/clearance activities. Total expected cash level at EOD—$9432.
Wednesday 1/3—2 cash management replenishments/clearance activities. Total expected cash level at EOD—$9032.

The summary provides a clear overview of the daily cash management activities and expected cash levels, allowing for better planning and resource allocation. Furthermore, the summary view helps store managers quickly assess the cash management needs for the week and/or the month and plan accordingly.

The media action scheduling MLM 115 is designed to continuously adjust its recommendations based on new observations and unexpected circumstances. As transactions are processed in real time on terminals 120 of a given store, state/status/media reporting agent 124 provides the real-time data with respect to deposited and dispensed media types and media denominations per terminal 120, which is updated and processed by MLM 115 to make dynamic real-time adjustments in its recommendations.

The system 100 is designed to balance between meeting the overall cash amount limitation per terminal while minimizing cash service activities. This balance is achieved through the multi-factor optimization approach of MLM 115, which considers both the need to keep cash levels within acceptable ranges and the goal of reducing the frequency of cash management activities. Moreover, system 100 allows for configuration of optimal media levels by denomination of media type per terminal 120 based on the optimal levels provided for each terminal 120 from media baseline MLM 114.

In an embodiment, transaction system 134 provides real-time media data with respect to deposited and dispensed media types and media denominations per terminal 120, which is updated and processed by MLM 115 to make dynamic real-time adjustments in its recommendations. Here, transaction system 134 utilizes agent 124 or transaction manager 123 to obtain real-time media data, which is then provided to MLM 115.

This adaptive approach ensures that the cash management strategy remains effective even as conditions change over time. The recommendations produced by the media action scheduling MLM 115 are made available through the API 116 and can be displayed in cash management dashboards accessible through store services 143 on user-operated devices 140. This allows store managers to easily view and act upon the optimized cash management schedule.

In an embodiment, API 116 provides recommendations directly to media scheduling system 135. This allows a CIT provider service to be automatically scheduled via the media scheduling system 135 based on the recommendations of MLM 115.

The integration of the media action scheduling MLM 115 with the sales forecast system 133 and transaction system 134 allows for a more comprehensive and accurate prediction of cash needs. By incorporating sales forecasts and real-time transaction data, the MLM 115 can adapt its recommendations to both long-term trends and short-term fluctuations in cash usage.

The system's ability to generate a cash management optimization schedule that is efficient enough to substantially cut labor costs while keeping terminals operational for extended periods reduces the reliance on real-time alerts. This proactive approach addresses the challenge of stores not always being able to support immediate responses to cash management alerts, providing a more sustainable and efficient cash management strategy.

In an embodiment, MLMs 114 and 115 are provided as a software-as-a-service (SaaS) to systems of other services. For example, an accounting system of a retailer can make requests for media baselines of terminals 120 to MLM 114 and for summary recommendations with media schedules for the terminals 120 to MLM 115 on demand or at preconfigured intervals of time for purposes of planning for and scheduling CIT service provider visits and/or in preparing cash and income statements for one or more stores of the retailer.

In an embodiment, terminals 120 can be SSTs 120 having recyclers, media depositories, and/or media dispensers that necessitate media activities. In an embodiment, terminals 120 are Automated Teller Machines (ATMs). In an embodiment, terminals 120 are POS terminals that include cash drawers accessed by a cashier of the store. In an embodiment, terminals 120 are a mixture or some combination of SSTs, ATMs, and/or POS terminals. In an embodiment, user-operated devices 140 can be any combination of phones, laptops, wearable processing devices, tablets, and/or desktops.

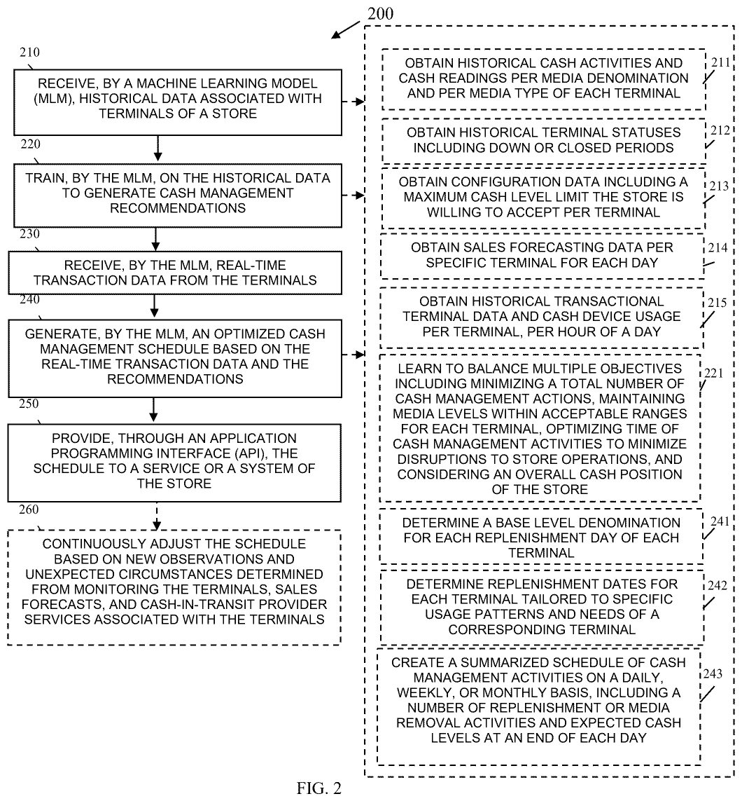

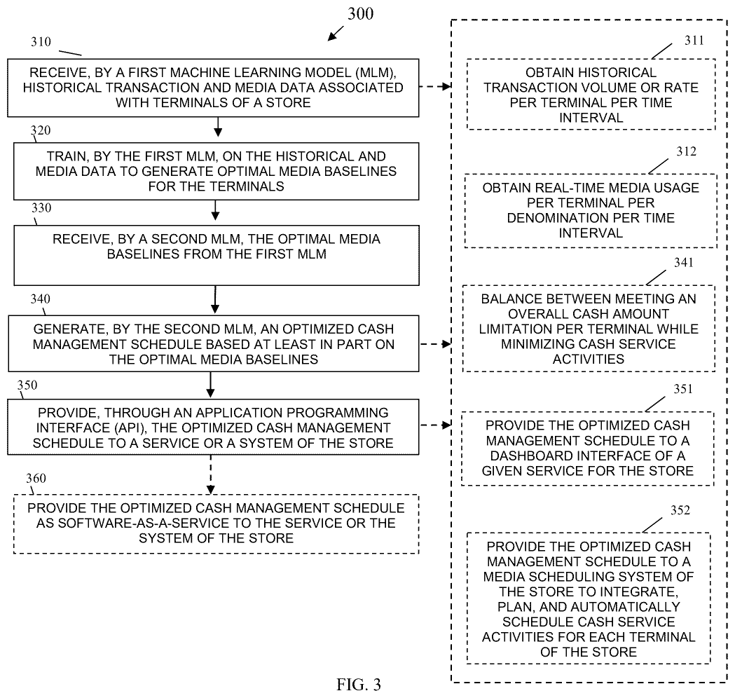

The above-referenced embodiments and other embodiments are now discussed with reference to FIGS. 2 and 3. FIG. 2 illustrates a flow diagram of a method 200 for media management optimization of a transaction terminal, according to an example embodiment. The software module(s) that implements the method 200 is referred to as a “media activity terminal predictor.” The media activity terminal predictor is implemented as executable instructions programmed and residing within memory and/or a non-transitory computer-readable (processor-readable) storage medium and executed by one or more processors of one or more devices. The processor(s) of the device(s) that executes the media activity terminal predictor are specifically configured and programmed to process the media activity terminal predictor. The media activity terminal predictor has access to one or more network connections during its processing. The connections can be wired, wireless, or a combination of wired and wireless.

In an embodiment, the device that executes media activity terminal predictor is cloud 110. In an embodiment, the device that executes media activity terminal predictor is server 110. In an embodiment, the devices that executes media activity terminal predictor is a retail server 130. In an embodiment, the media activity terminal predictor is all of, or some combination of 113, 114, 115, and/or 116. In an embodiment, the media activity terminal predictor is provided to a retail server 130 and/or a user-operated device 140 as a SaaS.

At 210, the media activity terminal predictor uses a media activity scheduling MLM 115 and the MLM 115 receives historical data associated with terminals 120. In an embodiment, at 211, the media activity terminal predictor obtains historical cash activities and cash readings per media denomination and per media type of each terminal 120. In an embodiment, at 212, the media activity terminal predictor obtains historical terminal statuses including down or closed periods for each terminal 120. In an embodiment, at 213, the media activity terminal predictor obtains configuration data including a maximum cash level limit the store is willing to accept per terminal 120. In an embodiment, at 214, the media activity terminal predictor obtains sales forecasting data from a sales forecast system 133 per specific terminal 120 for each day. In an embodiment, at 215, the media activity terminal predictor obtains historical transaction data and cash device usage per terminal 120, per hour of a day.

At 220, the MLM 115, trains on the historical data to generate cash management recommendations. In an embodiment, a trainer 113 trains and monitors the MLM 115 during a training session. In an embodiment, at 221, MLM 115 leans to balance multiple objectives including minimizing a total number of cash management actions, maintaining media levels within acceptable ranges for each terminal 120, optimizing time of cash management activities to minimize disruptions to store operations, and considering an overall cash position of the store.

At 230, the MLM 115 receives real-time transaction data from the terminals 120. At 240, the MLM 115, generates an optimized cash management schedule based on the real-time transaction data and the recommendations.

In an embodiment, at 241, the MLM 115 determines a base level denomination for each replenishment day of each terminal 120. In an embodiment, at 242, the MLM 115 determines replenishment dates for each terminal 120 tailored to specific usage patterns and needs of a corresponding terminal 120. In an embodiment, at 243, the MLM 115 creates a summarized schedule of cash management activities on a daily, weekly, or monthly basis, including a number of replenishment or media removal activities (i.e., media addition activities or media clearance activities) and expected cash levels at an end of each day.

At 250, the media activity terminal predictor uses an API 116, and the API 116 provides the optimized cash management schedule to a service/system 143 of the store. In an embodiment, at 260, the MLM 115 continuously adjusts the optimized cash management schedule based on new observations and unexpected circumstances determined from monitoring the terminals 120, sales forecasts, and CIT provider services associated with the terminals 120.

FIG. 3 illustrates a flow diagram of another method 300 for media management optimization of a transaction terminal, according to an example embodiment. The software module(s) that implements the method 300 is referred to as a “media management optimizer.” The media management optimizer is implemented as executable instructions programmed and residing within memory and/or a non-transitory computer-readable (processor-readable) storage medium and executed by one or more processors of one or more devices. The processor(s) of the device(s) that executes the media management optimizer are specifically configured and programmed to process the media management optimizer. The media management optimizer has access to one or more network connections during its processing. The network connections can be wired, wireless, or a combination of wired and wireless.

In an embodiment, the device that executes the media management optimizer is cloud 110. In an embodiment, the device that executes the media management optimizer is server 110. In an embodiment, the device that executes the media management optimizer is retail server 130. In an embodiment, the media management optimizer is provided to a retail server 130 and/or a user-operated device 140 as a SaaS.

In an embodiment, the media management optimizer is all of, or some combination of 113, 114, 115, 116, and/or method 200. The media management optimizer presents another and, in some ways, enhanced processing perspective from that which was discussed above with the method 200 of the FIG. 2.

At 310, the media management optimizer uses a first MLM 114, and the first MLM 114 receives historical transaction and media data associated with terminals 120 of the store. In an embodiment, at 311, the media management optimizer obtains historical transaction volume or rate per terminal 120 per time interval. In an embodiment, at 312, the media management optimizer obtains real-time media usage per terminal 120 per denomination per time interval.

At 320, the first MLM 114 trains on the historical and media data to generated optimal media baselines for the terminals 120. In an embodiment, a first trainer 113 trains and monitors the first MLM 114 during a training session.

At 330, the media management optimizer uses a second MLM 115, and the second MLM 115 receives the optimal media baselines from the first MLM 114. At 340, the second MLM 115 generates an optimized cash management schedule based at least in part on the optimal media baselines. In an embodiment, at 341, the second MLM 115 balances between meeting an overall cash amount limitation per terminal 120 while minimizing cash service activities.

At 350, the media management optimizer uses an API 116, and the API 116 provides the optimized cash management schedule to a service/system 143 of the store. In an embodiment, at 351, the API 116 provides the optimized cash management schedule to a dashboard interface of a given service 143 for the store. In an embodiment, at 352, the API 116 provides the optimized cash management schedule to a media activity scheduling system 115 of the store to integrate, plan, and automatically schedule cash service activities for each terminal 120 of the store.

In an embodiment, the media management optimizer including the first MLM 114 and the second MLM 115 are provides as SaaS to the service/system 143 of the store. The first MLM 114 and the second MLM 115 integrated via API 116.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving, by a machine learning model (MLM) executing on a processor of a cloud server, historical data associated with terminals of a store;
training, by the MLM, on the historical data to generate cash management recommendations;
receiving, by the MLM, real-time transaction data from the terminals;
generating, by the MLM, an optimized cash management schedule based on the real-time transaction data and the cash management recommendations; and
providing, through an application programming interface (API), the optimized cash management schedule to a service or a system of the store.

2. The method of claim 1, wherein receiving the historical data further includes obtaining historical cash activities and cash readings per media denomination and per media type of each terminal.

3. The method of claim 1, wherein receiving the historical data further includes obtaining historical terminal statuses, including down or closed periods.

4. The method of claim 1, wherein receiving the historical data further includes obtaining configuration data including a maximum cash level limit the store is willing to accept per terminal.

5. The method of claim 1, wherein receiving the historical data further includes obtaining sales forecasting data per specific terminal for each day.

6. The method of claim 1, wherein receiving the historical data further includes obtaining historical transaction terminal data and cash device usage per terminal, per hour of a day.

7. The method of claim 1, wherein training further includes learning to balance multiple objective including minimizing a total number of cash management actions, maintaining media levels within acceptable ranges for each terminal, optimizing timing of cash management activities to minimize disruptions to store operations, and considering an overall cash position of the store.

8. The method of claim 1, wherein generating further includes determining a base level denomination for each replenishment day of each terminal.

9. The method of claim 1, wherein generating further includes determining replenishment dates for each terminal tailored to specific usage patterns and needs of a corresponding terminal.

10. The method of claim 1, wherein generating further includes creating a summarized schedule of cash management activities on a daily, weekly, or monthly basis, including a number of replenishment or media removal activities and expected cash levels at an end of each day.

11. The method of claim 1, further comprising:
continuously adjusting the optimized cash management schedule based on new observations and unexpected circumstances determined from monitoring the terminals of the store, sales forecasts for the store, and cash-in-transit provider services associated with the terminals.

12. A method, comprising:
receiving, by a first machine learning model (MLM) executing on a processor of a cloud server, historical transaction and media data associated with terminals of a store;
training, by the first MLM executing on the processor of the cloud server, based on the historical transaction and media data to generate optimal media baselines for the terminals;
receiving, by a second MLM executing on the processor of the cloud server, the optimal media baselines from the first MLM;
generating, by the second MLM, an optimized cash management schedule based at least in part on the optimal media baselines; and
providing, through an application programming interface (API), the optimized cash management schedule to a service or a system of the store.

13. The method of claim 12, wherein receiving further includes obtaining historical transaction volume or rate per terminal per time interval.

14. The method of claim 12, wherein receiving further includes obtaining real-time media usage per terminal per denomination per time interval.

15. The method of claim 12, wherein generating further includes balancing between meeting an overall cash amount limitation per terminal while minimizing cash service activities.

16. The method of claim 12, wherein providing further includes providing the optimized cash management schedule to a dashboard interface of a given service for the store.

17. The method of claim 12, wherein providing further includes providing the optimized cash management schedule to a media scheduling system of the store to integrate, plan, and automatically schedule cash service activities for each of the terminals of the store.

18. The method of claim 12, further comprising:
providing the optimized cash management schedule as a software-as-a-service to the service or the system of the store.

19. A system, comprising:
a cloud server comprising at least one processor and a non-transitory computer-readable storage medium;
the non-transitory computer-readable storage medium comprises executable instructions;
the executable instructions when provided to and executed by the at least one processor from the non-transitory computer-readable storage medium cause the at least one processor to perform operations comprising:
training a media baseline machine learning model (MLM) based on historical transaction and media data to generate optimal media baselines for transaction terminals of a store;
training a media action scheduling MLM on historical data and the optimal media baselines to generate cash management recommendations;
receiving real-time transaction data from the transaction terminals;
generating, by the media action scheduling MLM, an optimized cash management schedule based on the cash management recommendations and the real-time transaction data; and
providing, through an application programming interface (API), the optimized cash management schedule to a service or a system of the store.

20. The system of claim 19, wherein generating the optimized cash management schedule further includes creating a summary of cash management activities including a number of cash management replenishments or media clearance activities and a total expected cash level at end-of-day for each day in a given time period.
